(19) United States
(12) Patent Application Publication
(10) Pub. No.: US 2012/0304290 A1
(43) Pub. Date: Nov. 29, 2012

(54) CYBER ISOLATION, DEFENSE, AND MANAGEMENT OF A INTER-/INTRA- ENTERPRISE NETWORK

(76) Inventor: LON DANIEL MCPHAIL, San Diego, CA (US)

(21) Appl. No.: 13/406,436

(22) Filed: Feb. 27, 2012

Related U.S. Application Data
(60) Provisional application No. 61/447,658, filed on Feb. 28, 2011.

(51) Int. Cl. G06F 21/00

(52) U.S. Cl. 726/22

(57) ABSTRACT

Methodologies, tools and processes for the cyber isolation, defense, and management of an inter-/intra-enterprise network utilizing NSA-approved Type-1 encryptors to first completely isolate all HardNet fixed and mobile participants from the logical internet. Secondly, to enable inter-corporation traffic exchange while maintaining the established security barrier. Next, to create a network demarcation point through which all traffic shall enter or exit HardNet, and through which all traffic shall be inspected with DoD grade cyber security and information assurance (IA) capabilities. Effective net end result is a weapons-grade cyber security shield and cyber management capability for the business, educational, non-profit, governmental and all other enterprises.

### CROSS-REFERENCE TO RELATED APPLICATIONS

The present application claims priority from U.S. Provisional Patent Application No. 61/447,658 filed Feb. 28, 2011, which is expressly incorporated by reference herein.

### BACKGROUND OF THE INVENTION

1. Field of the Invention

The present invention relates to network security systems and methods.

2. Description of Related Art

Cyber security, Information Assurance (IA), and Information Operations (IO) demands are doubling regularly as malware, Cybercrime and Cyberwar becomes an increasing reality. The current stable of federal contractors is populated by a large amount of small, medium and larger organizations that cannot afford the overwhelming burden required to protect, secure and defend their cyber capabilities.

### BRIEF SUMMARY OF THE INVENTION

Certain embodiments of the invention provide methodologies, tools and processes for the cyber isolation, defense, and management of a inter-/intra-enterprise network, which in some of these embodiments, enables discrete strategic capabilities including a cost-effective solution which enables each of the individual contractors to gain cyber protection such as:
Cross-Domain Security
Trusted, Secure Communications
DoD/Weapons-Grade Cyber Protection
Application and Network Management
Smartphone defense and protection
Active, 24/7/365 NOG-level management

### BRIEF DESCRIPTION OF THE DRAWINGS

Figures contained herein depict both notional and actual environments which have capabilities as separate entities, and additional, advanced capabilities which are in addition to the individual functions, when joining any two or more components together. Drawings indicate many of the components, and some of the compounding effects of combining capabilities together. Drawings are in no way representational of the full capabilities of any permutation possible when considering the potential of one or more components.

FIG. 1 illustrates a process host architecture according to certain aspects of the invention.

FIG. 2 depicts a process System View Level 1 (DoDAF SV-1) according to certain aspects of the invention.

FIG. 3 is a Quad-Chart description of according to certain aspects of the invention.

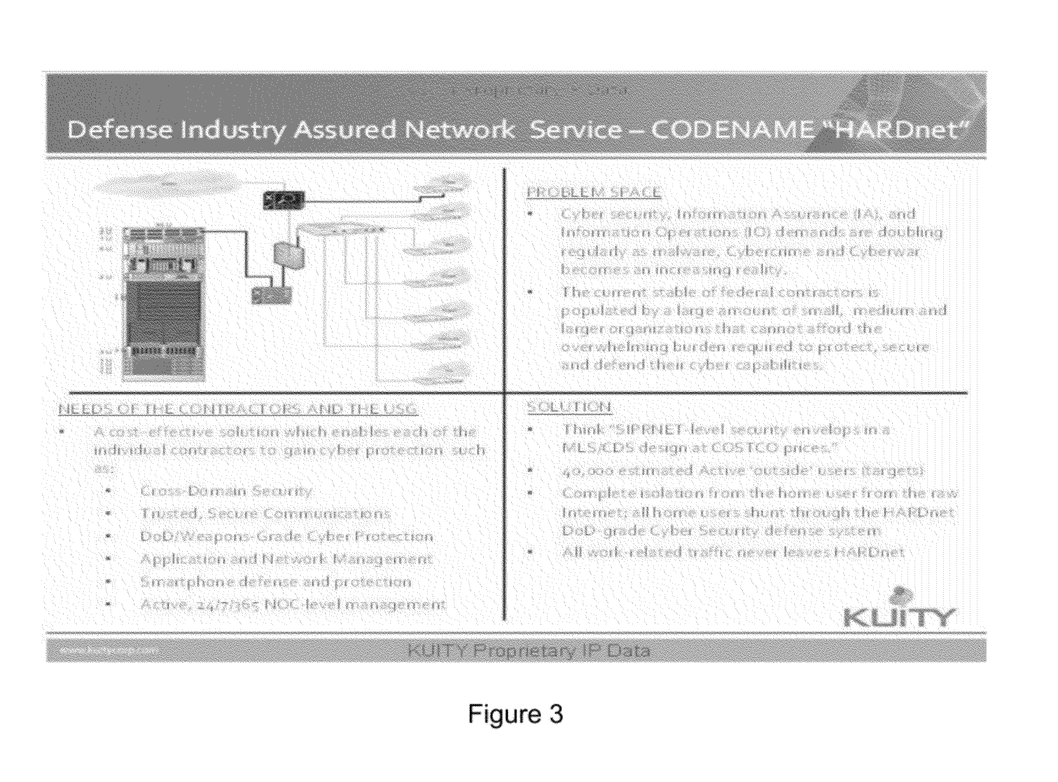

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention comprise systems and methods applicable to secured networks and computer systems. For the purposes of simplifying descriptions, an example embodiment will be described herein. The embodiment comprises a network of computers and communication equipment is referred to herein as “HardNet.” Hardnet is configured and configurable to exclude unauthorized users from accessing, viewing and/or contacting system resources. Certain embodiments deliver effective capabilities, including:
a. “SIPRNET-level security envelopes in a MLS/CDS design.”
b. Complete isolation from the home user and the traveling corporate asset from the raw Internet; all users shunt through the HARDnet DoD-grade Cyber Security defense system.
c. All work-related traffic never leaves HARDnet.
d. All exfiltration of data must be authorized prior to it's release.
   In certain embodiments, an effective solution is provided that enables each of a plurality of individual contractors to gain cyber protection including cross-domain security. Each of the individual contractors can gain cyber protection including trusted, secure communications. In some embodiments, each of the individual contractors can obtain cyber protection that includes DoD/Weapons-Grade Cyber Protection. Additionally, each of the individual contractors can benefit from secured application and network management. The protections obtained can be extended to provide defense and protection for portable computing devices including computers and smartphones. In certain embodiments, cypber protection offered to contractors meets or exceeds standards such as active, 24/7/365 NOG-level management.

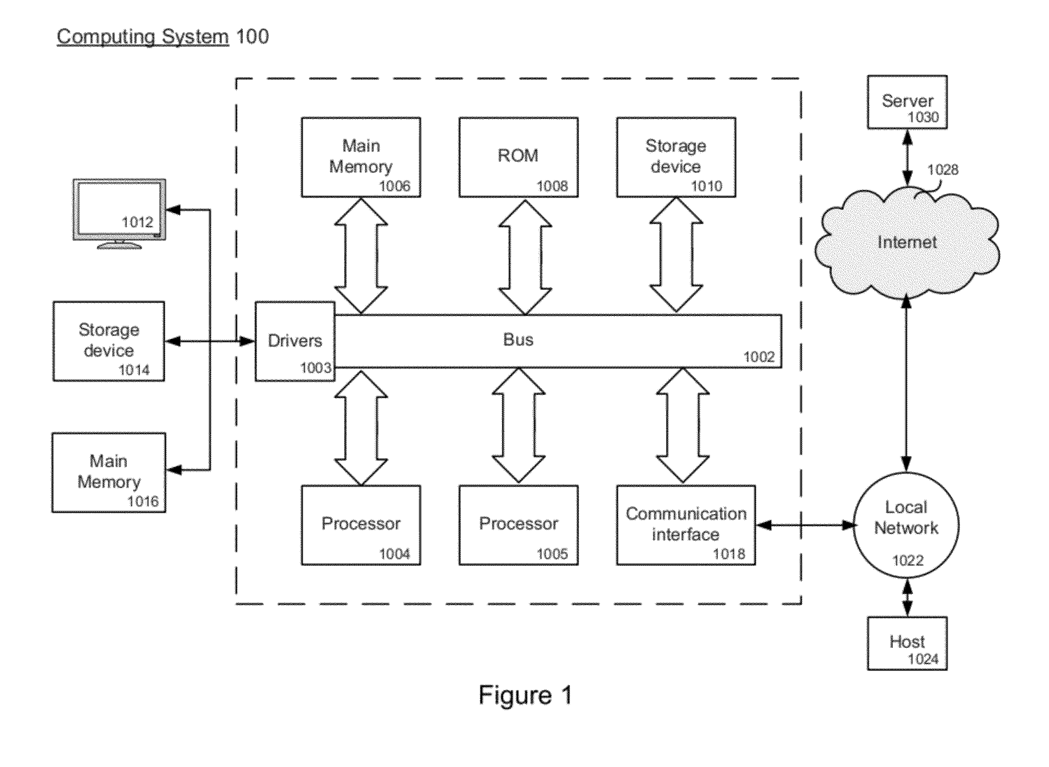

In certain embodiments, NSA-approved Type 1 encryptors can be utilized to first completely isolate all HardNet fixed and mobile participants from the logical internet. Secondly, to enable inter-corporation traffic exchange while maintaining the established security barrier. Next, to create a network demarcation point through which all traffic is directed for entry or exit of HardNet, and through which all traffic can be inspected with DoD grade cyber security and information assurance (IA) capabilities. Note that the components illustrated in FIG. 1 are representational, and do not necessarily represent the entire field of additional factors.

Certain embodiments reflect an execution methodology which comprises a serialized work-flow, described herein. This description is intended to illustrate certain principle actions required to provide insight into the enterprise for intended actions, and is not meant to represent the complete list of all actions. Certain embodiments provide a cost-effective solution which enables each of the individual contractors to gain cyber protection including cross-domain security; trusted, secure Communications; DoD/weapons-grade cyber protection; application and network management; smartphone defense and protection; and active, 24/7/365 NOG-level management.

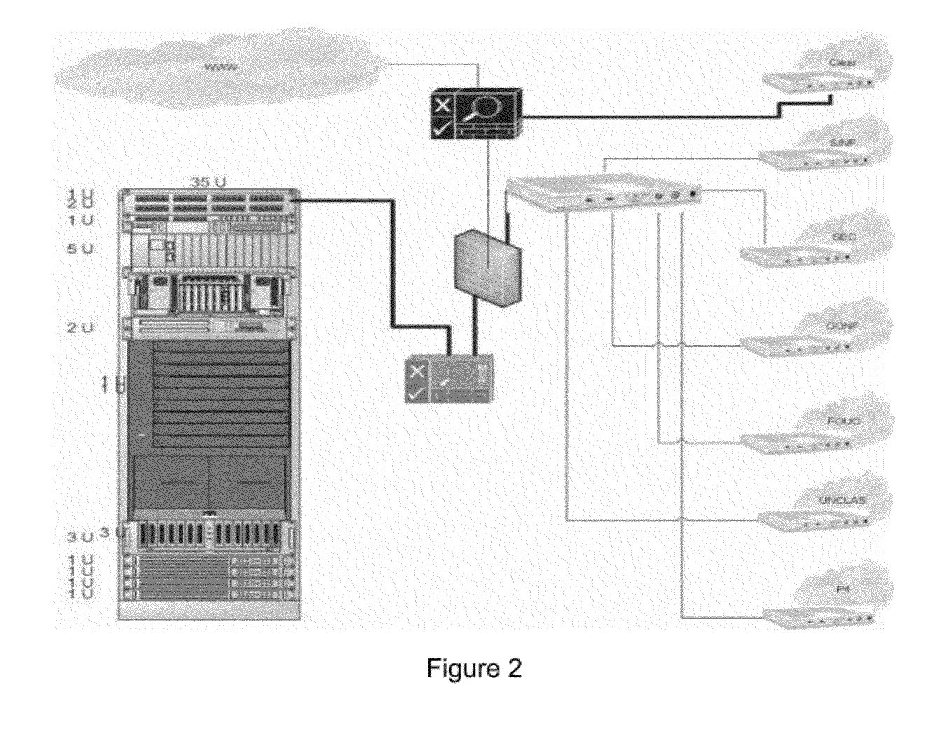

FIGS. 1-2 depict within certain orientation markers. The methodologies, tools and processes for the cyber isolation, defense, and management of an inter-/intra-enterprise network isolates, protects, defends, and manages related enterprise cyber communications and inter-/intra-operations data transport. The methodologies, tools and processes for the cyber isolation, defense, and management of an inter-/intra-enterprise network as set forth in this Application for Patent under 37 CFR 1.53(c), details a unique and non-obvious Art which is eligible for U.S Patent protection.

### System Description

Turning now to FIG. 1, certain embodiments of the invention employ one or more processing systems that perform various of the above described processes and functions. A processing system can include at least one computer or computing system 100 typically deployed in a network. Suitable computing systems may be comprise commercially available or custom computers that execute commercially available operating systems such as Microsoft Windows®, UNIX or a variant thereof, Linux, a real time operating system and or a proprietary operating system. The architecture of the computing systems may be adapted, configured and/or designed for integration in the processing system, for embedding in one or more of an image capture system, a manufacturing/machining system, a graphics processing workstation and/or a surgical system or other medical management system. In one example, computing system 100 comprises a bus 102 and/or other mechanisms for communicating between processors, whether those processors are integral to the computing system 10 (e.g. 104, 105) or located in different, perhaps physically separated computing systems 100.

Computing system 100 also typically comprises memory 106 that may include one or more of random access memory (“RAM”), static memory, cache, flash memory and any other suitable type of storage device that can be coupled to bus 102. Memory 106 can be used for storing instructions and data that can cause one or more of processors 104 and 105 to perform a desired process. Main memory 106 may be used for storing transient and/or temporary data such as variables and intermediate information generated and/or used during execution of the instructions by processor 104 or 105. Computing system 100 also typically comprises non-volatile storage such as read only memory (“ROM”) 108, flash memory, memory cards or the like; non-volatile storage may be connected to the bus 102, but may equally be connected using a high-speed universal serial bus (USB), Firewire or other such bus that is coupled to bus 102. Non-volatile storage can be used for storing configuration, and other information, including instructions executed by processors 104 and/or 105. Non-volatile storage may also include mass storage device 110, such as a magnetic disk, optical disk, flash disk that may be directly or indirectly coupled to bus 102 and used for storing instructions to be executed by processors 104 and/or 105, as well as other information.

Computing system 100 may provide an output for a display system 112, such as an LCD flat panel display, including touch panel displays, electroluminescent display, plasma display, cathode ray tube or other display device that can be configured and adapted to receive and display information to a user of computing system 100. In that regard, display 112 may be provided as a remote terminal or in a session on a different computing system 100. In certain embodiments, results may be used to control automated systems, including purchasing systems, manufacturing control systems, HVAC, plant management and other systems. An input device 114 is generally provided locally or through a remote system and typically provides for alphanumeric input as well as cursor control 116 input, such as a mouse, a trackball, etc. It will be appreciated that input and output can be provided to a wireless device such as a PDA, a tablet computer or other system suitable equipped to display the images and provide user input.

In one example according to one embodiment of the invention, processor 104 executes one or more sequences of instructions. For example, such instructions may be stored in main memory 106, having been received from a computer-readable medium such as storage device 110. Execution of the sequences of instructions contained in main memory 106 causes processor 104 to perform process steps according to certain aspects of the invention. In certain embodiments, functionality may be provided by embedded computing systems that perform specific functions wherein the embedded systems employ a customized combination of hardware and software to perform a set of predefined tasks. Thus, embodiments of the invention are not limited to any specific combination of hardware circuitry and software.

The term “computer-readable medium” is used to define any medium that can store and provide instructions and other data to processor 104 and/or 105, particularly where the instructions are to be executed by processor 104 and/or 105 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 104 and 105 or remotely, typically by use of network connection. Non-volatile storage may be removable from computing system 104, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 100. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 104 and/or 105. For example, the instructions may initially be retrieved from a magnetic disk of a remote computer and transmitted over a network or modem to computing system 100. The instructions may optionally be stored in a different storage or a different part of storage prior to or during execution.

Computing system 100 may include a communication interface 118 that provides two-way data communication over a network 120 that can include a local network 122, a wide area network or some combination of the two. For example, an integrated services digital network (ISDN) may used in combination with a local area network (LAN). In another example, a LAN may include a wireless link. Network link 120 typically provides data communication through one or more networks to other data devices. For example, network link 120 may provide a connection through local network 122 to a host computer 124 or to a wide are network such as the Internet 128. Local network 122 and Internet 128 may both use electrical, electromagnetic or optical signals that carry digital data streams.

Computing system 100 can use one or more networks to send messages and data, including program code and other information. In the Internet example, a server 130 might transmit a requested code for an application program through Internet 128 and may receive in response a downloaded application that provides for the anatomical delineation described in the examples above. The received code may be executed by processor 104 and/or 105.

What is claimed is:

1. A method, comprising:
enabling each of a plurality of individual contractors to obtain cyber protections, the cyber protections including at least one of cross-domain security, trusted communication, secure communications, DoD weapons-grade cyber protection, DoD approved cyber protection, application and network management, smartphone defense, smartphone protection, and active, 24/7/365 NOG-level management.

2. The method of claim 1, wherein the cyber protections relate to an enterprise system comprising one or more information technology systems.

3. The method of claim 2, wherein the cyber protections include controlled access rights to systems and networks within the enterprise system.

4. The method of claim 2, wherein the cyber protections include protections of a plurality of data sources.

5. The method of claim 4, wherein the plurality of data sources include data sources external to the enterprise.

6. The method of claim 4, wherein the plurality of data sources include data sources within the enterprise.

7. The method of claim 4, wherein the plurality of data sources include data sources within a domain of the enterprise.
